(19) United States
(12) Patent Application Publication
(10) Pub. No.: US 2011/0000777 A1
(43) Pub. Date: Jan. 6, 2011

(54) Vapor compression distillation system

(76) Inventor: Yun Yan Zhou, Mountain View, CA (US)

Correspondence Address: Yun Yan Zhou, 283 Fair Oaks St., Mountain View, CA, 94040, US

(21) Appl. No.: 12/459,520

(22) Filed: Jul. 3, 2009

(51) Int. Cl. B01D 3/26

(52) U.S. Cl. 202/180

(57) ABSTRACT

A vapor compression distillation system is disclosed. A pulsed power scale prevention module is provided in a recirculation loop of an evaporation loop and in each of a plurality of pre-evaporation heat exchange loops to nucleate contaminant particles in the liquid. The nucleated contaminant particles are removed from the system by filters in communication with the pulsed power scale prevention modules and by solids collection and discharge ports provided by heat exchangers in the evaporation loop and each of the pre-evaporation heat exchange loops. The evaporation loop and the pre-evaporation heat exchange loops provide a temperature gradient having discreet temperature zones.

### BACKGROUND OF THE INVENTION

The present invention relates generally to vapor compression distillation systems and more particularly to a scale-resistant vapor compression distillation system employing pulsed power devices for use in wastewater concentration, treatment, remediation, reuse, and zero-discharge applications.

Vapor compression distillation is a well known process whereby a liquid is first vaporized in an evaporation tank and then compressed by a vapor compressor. The heat from the compressed vapor is then used to heat the “mother” liquid or solution being distilled in a heat exchanger. The efficiency and feasibility of this process is dependent upon the efficiency of the vapor compressor and the heat transfer coefficient attained in the heat exchanger.

Scaling of the vapor compression distillation system adversely affects the efficiency of the process as deposited scale has low thermal conductivity and significantly reduces heat transfer efficiency. Scaling is due to many factors including the concentration of contaminants in the liquid or solution, the affinity of contaminants to metal surfaces, and the extent of turbulence of the flows within the distillation system.

The prior art discloses various anti-scaling techniques including the use of scale inhibiting chemicals such as acrylic polymers, polyphosphates and polyaspartates. Other techniques include the use of turbulators as disclosed in U.S. Pat. No. 6,365,005 issued to Schleiffarth, the use of wipers in the evaporating chambers as disclosed in U.S. Pat. No. 6,261,419 issued to Zebuhr, and spacing the heat exchanger plates slightly apart to eliminate contact points where scale may accumulate as disclosed in U.S. Pat. No. 5,858,177 issued to Morris.

Pulsed power devices have been used to treat water and reduce scaling in evaporative coolers with proven results. Additionally, and as disclosed in U.S. Patent Application No. 2009/0152207, a process to reduce or prevent biofouling by destroying or deactivating microbiological content of feedwater prior to the entrance into membranes or process equipment includes the use of electrical discharge and/or pulsed electric fields.

There remains a need in the art for a vapor compression distillation system that is scale resistant and that does not employ the use of chemicals, except during periodic system cleaning. There is a further need for a vapor compression distillation system that employs pulsed power devices to provide scale resistance.

### SUMMARY OF THE INVENTION

The vapor compression distillation system in accordance with the invention provides a scale-resistant distillation system that includes a plurality of pulsed power scale prevention modules in each of an evaporation loop and a plurality of pre-evaporation heat exchange loops. Each of the pulsed power scale prevention modules includes a high frequency pulse generator and a reaction chamber. The high frequency pulse generator is operable to induce a high frequency, time varying electromagnetic field into wastewater circulating through the reaction chamber.

Further, the evaporation loop includes a recirculation loop including a recirculation pump operable to circulate the wastewater within the loop. Each pre-evaporation heat exchange loop also includes a recirculation pump. Recirculation within the each loop provides for increased exposure of the wastewater within the loop to the electromagnetic field provided by each pulsed power scale prevention module.

In accordance with an aspect of the invention, the surfaces of the vapor compression distillation system in contact with fluid are treated by anodized coating, electro-coating, powder or spray coatings with fluoropolymers to protect the surfaces against corrosion and to minimize scale caking and fouling by providing a substantially frictionless surface.

In accordance with another aspect of the invention, each of the evaporation loop and the plurality of pre-evaporation heat exchange loops includes a heat exchanger having a solids collection and discharge port.

In accordance with another aspect of the invention, each of the evaporation loop and the plurality of pre-evaporation heat exchange loops includes a mechanical or cyclonic filter.

In accordance with another aspect of the invention, the vapor compression distillation system provides a temperature gradient having discreet temperature zones in each of the evaporation loop and the plurality of pre-evaporation heat exchange loops.

In accordance with another aspect of the invention, the vapor compression distillation system provides a system wherein the temperature of the distillate at an outlet of the system is only slightly higher than the temperature of the wastewater feed at an inlet thereof.

In accordance with another aspect of the invention, the vapor compression distillation system provides for higher distillation efficiency as frequent blow downs are not necessary to avoid super-saturation.

In accordance with another aspect of the invention, scaling solids are filtered and discharged from the system as they are formed.

In accordance with another aspect of the invention, a method of preventing scaling in a vapor compression distiller includes providing an evaporation loop and providing a plurality of pre-evaporation heat exchange loops in fluid communication with the evaporation loop, each of the evaporation loop and the plurality of pre-evaporation heat exchange loops having a pulsed power scale prevention module.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of design and to the arrangement of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent methods and systems insofar as they do not depart from the spirit and scope of the present invention.

### BRIEF DESCRIPTION OF THE DRAWINGS

The present disclosure may be better understood and its numerous features and advantages made apparent to those skilled in the art by referencing the accompanying drawings wherein:

FIG. 1 is a schematic representation of a vapor compression distillation system in accordance with the invention;

FIG. 2 is a schematic representation of an evaporation loops of the vapor compression distillation system of FIG. 1;

FIG. 3 is a schematic representation of a pre-evaporation heat exchanger loop of the vapor compression distillation system of FIG. 1; and

FIG. 4 is a flow diagram illustrating a vapor compression distillation process in accordance with the invention.

### DETAILED DESCRIPTION OF THE INVENTION

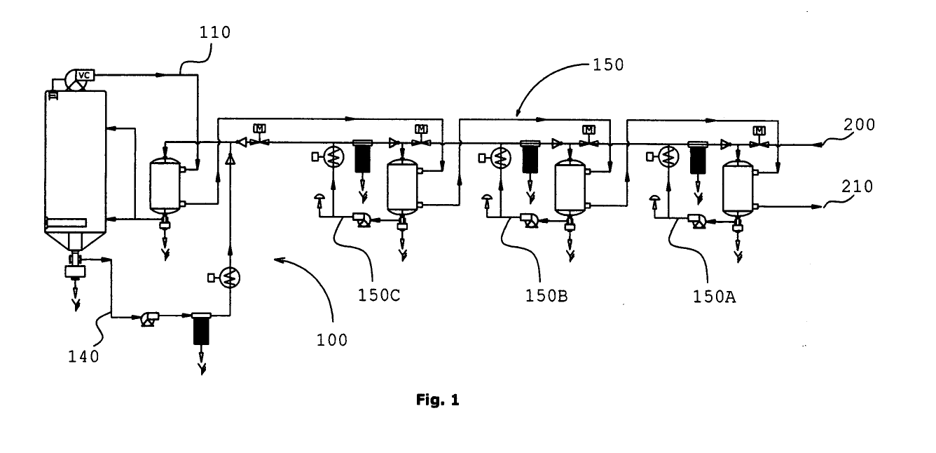

A vapor compression distillation system (VCDS) generally designated 100 in accordance with the invention will now be described with reference to FIG. 1. The VCDS 100 generally includes an evaporation loop 110 and a plurality of pre-evaporation heat exchange loops generally designated 150. Three such pre-evaporation heat exchange loops 150a, 150b and 150c are shown in FIG. 1. Preferably the number of pre-evaporation heat exchange loops 150 is between three and six.

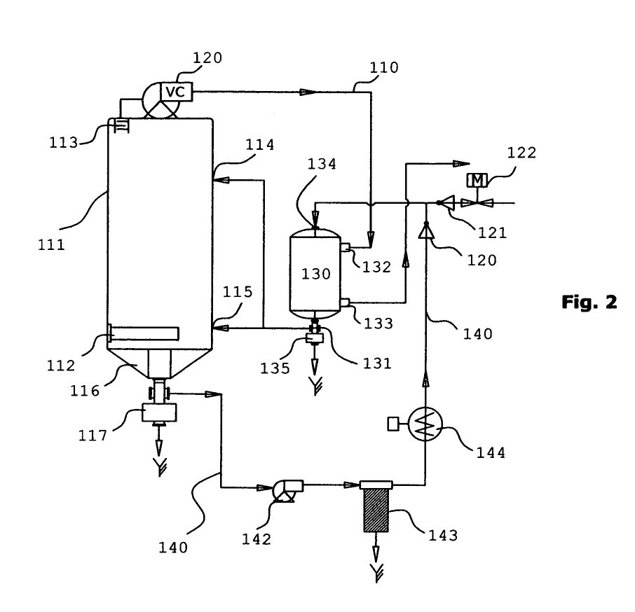

With reference to FIG. 2, the evaporation loop 110 includes an evaporation tank 111 and a heat exchanger 130 in fluid communication therewith. The evaporation tank 111 is of conventional design and has a heater 112 and a baffle/mist filter 113. Evaporation tank high and low inlets 114 and 115 respectively are in fluid communication with a heat exchanger liquid recirculation outlet 131. A vapor compressor 120 is disposed between the evaporation tank 111 and the heat exchanger 130 in fluid communication with each and is operable to compress vapors received from the evaporation tank 111. The compressed vapors enter the heat exchanger 130 at a steam side inlet 132 thereof and exit the heat exchanger 130 as a distillate at a steam side outlet 133. The steam side outlet 133 is in fluid communication with a steam side inlet of a heat exchanger of a succeeding pre-evaporation heat exchange loop and a heat exchanger liquid re-circulation inlet 134 is fluidly coupled to a wastewater feed from the succeeding pre-evaporation heat exchange loop as further described herein.

The evaporation loop 110 further includes a recirculation loop 140. Recirculation loop 140 is in fluid communication with an evaporation tank recirculation outlet 141 disposed at a bottom 116 of the evaporation tank 111 and the heat exchanger liquid recirculation inlet 134. Wastewater is re-circulated within the recirculation loop 140 by means of a recirculation pump 142 and passed through a pulsed power scale prevention module 143 and a mechanical or cyclonic filter 143. An exemplary pulsed power scale prevention module 143 is available from Clearwater Systems of Essex, Conn. A check valve 120 is provided in the recirculation loop 140 to ensure that the wastewater flows in the direction indicated by the arrows.

The pulsed power scale prevention module 143 in accordance with the invention is operable to repeatedly expose the wastewater circulating in the recirculation loop 140 to a pulsating electromagnetic field. Repeated exposure to the electromagnetic field alters the electrical charge of mineral particles so that they form colloidal nucleating powder or crystals. Colloidal nucleating powder or crystals are filtered by the filter 143 and collected and discharged by solids collection and discharge ports 117 and 135 coupled to the evaporation tank 110 and the heat exchanger 130 respectively rather than being deposited onto surfaces of the VCDS 100.

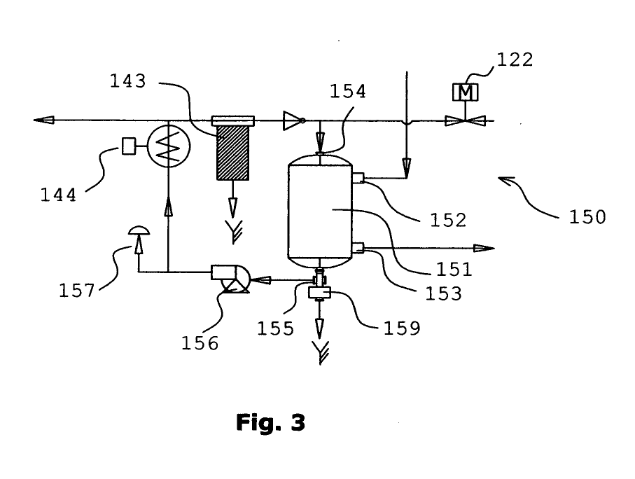

With reference to FIG. 3, the pre-evaporation heat exchange loop 150 includes a heat exchanger 151 having a steam side inlet 152 and a steam side outlet 153. The steam side inlet 152 is fluidly coupled to a steam side outlet of a preceding loop (either the evaporation loop 110 or another pre-evaporation heat exchange loop 150). The steam side outlet 153 is fluidly coupled to a steam side inlet of a succeeding loop or, in the case where the pre-evaporation heat exchange loop 150 is a last loop (such as loop 150a), to a distilled water outlet 210.

Heat exchanger 151 further includes a liquid recirculation inlet 154 and a liquid recirculation outlet 155. The liquid recirculation inlet 154 is fluidly coupled to a wastewater feed from a succeeding loop or, in the case where the pre-evaporation exchange loop 150 is the last loop, to a wastewater feed 200. The liquid recirculation outlet 155 is fluidly coupled to a recirculation pump 156 operable to re-circulate wastewater through a pulsed power scale prevention module 144 and a mechanical or cyclonic filter 143, and to the liquid recirculation inlet 154 through a check valve 158. A degasser 157 is also provided. Colloidal nucleating powder or crystals are filtered by the filter 143 and collected and discharged by a solids collection and discharge port 159 coupled to the heat exchanger 151 rather than being deposited onto surfaces of the VCDS 100.

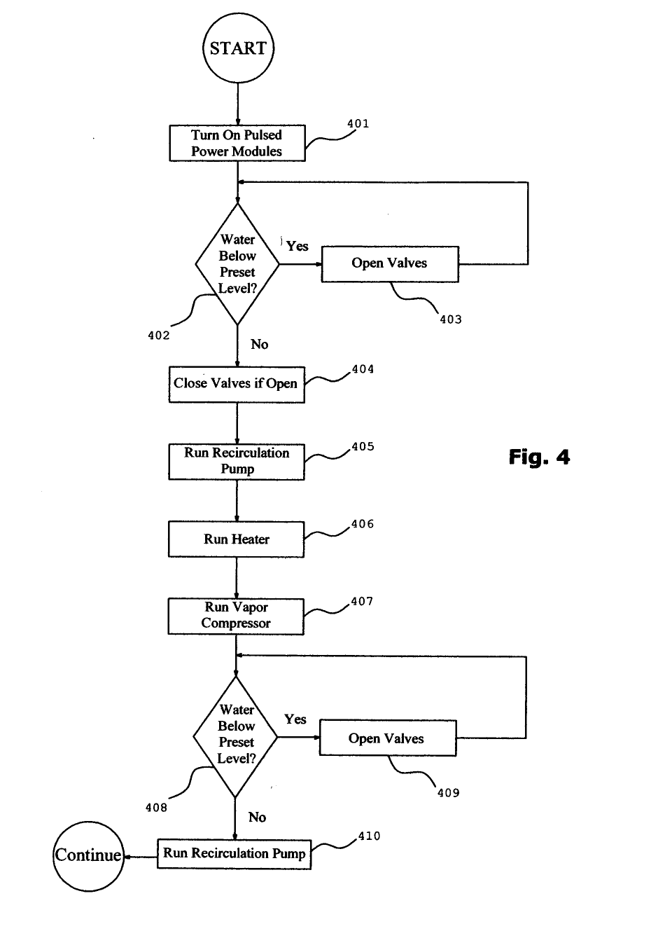

In accordance with a process 400 illustrated in FIG. 4, the VCDS 100 is started and in a step 401 the pulsed power scale prevention modules 144 are turned on. A determination is made in a step 402 whether the water level in the evaporation tank 111 is below a pre-set level. If the water level is below the pre-set level, then in a step 403 pneumatic or motorized valves 122 are opened until the water level reaches the pre-set level. If the water level is not below the pre-set level, then in a step 404 the valves 122 are closed if they are open.

The recirculation pumps 142 and 156 are turned on in a step 405. The frequency of operation of the recirculation pumps 142 and 156 is determined by the quality of the wastewater. For wastewater having a high scaling potential, the recirculation pumps 142 and 156 may be run continuously. For water with a low scaling potential, the pumps may be run intermittently.

The heater 112 is turned on in a step 406 and once the temperature of the wastewater in the evaporation tank 111 reaches a pre-set value (preferably between 212 and 230 degrees Fahrenheit) the vapor compressor 120 is turned on. The rotating speed and pressure of the vapor compressor 120 may be controlled by a variable frequency drive (not shown).

During operation of the VCDS 100, the water level in the evaporation tank 111 drops below the pre-set level. In a step 408 a determination is made whether the water level is below the pre-set level. If the water level is below the pre-set level, then in a step 409 the pneumatic or motorized valves 122 are opened until the water level reaches the pre-set level. If the water level is not below the pre-set level, then in a step 410 the valves 122 are closed if they are open and the process 400 continues until stopped.

Scale formation on the surfaces of the VCDS 100 is limited by several factors including the operation of the pulsed power scale prevention modules in combination with the mechanical or cyclonic filters and solids collection and discharge ports. Additional scale resistance is provided by coating the surfaces of the VCDS 100 in contact with wastewater with fluoropolymers to protect the surfaces against corrosion and to minimize scale caking and fouling by providing a substantially frictionless surface. Such coating may be an anodized coating, an electro-coating, and a powder or spray coating. Preferably the flouropolymer includes one or a combination of ERFE, E-CTFE, FEP, MFA, PFA and PTFE.

Scale formation is further limited by fast flowing liquid in the evaporation loop 110 and the pre-evaporation heat exchange loops 150 provided by the operation of the recirculation pumps 142 and 156.

The VCDS 100 can operate over a super-saturation level. To prevent scale formation, prior art techniques generally require frequent blow down to avoid super-saturation of the liquid. A large amount of liquid is therefore required to be discharged. In contrast, the VCDS 100 discharges clumps of salts as they are formed when the liquid is super saturated. Frequent blow down is thus not necessary and a larger amount of distilled water is recovered from the raw feed water compared to the prior art techniques.

The VCDS 100 also provides a temperature gradient having discreet temperature zones in each of the evaporation loop and the plurality of pre-evaporation heat exchange loops. The highest temperature zone corresponds to the evaporation loop and the lowest temperature zone corresponds to the pre-evaporation heat exchange loop nearest to the wastewater feed. The temperate of the distilled water exiting the VCDS 100 is only slightly higher than the temperature of the wastewater in the heat exchanger of the pre-evaporation heat exchange loop nearest to the wastewater feed.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

I claim:

1. A vapor compression distillation system comprising:
an evaporation loop; and
a plurality of pre-evaporation heat exchange loops in fluid communication with the evaporation loop, each of the evaporation loop and the plurality of pre-evaporation heat exchange loops having a pulsed power scale prevention module.

2. The vapor compression distillation system of claim 1, wherein each of the evaporation loop and the plurality of pre-evaporation heat exchange loops has a recirculation pump in fluid communication with the pulsed power scale prevention module.

3. The vapor compression distillation system of claim 1, wherein each of the evaporation loop and the plurality of pre-evaporation heat exchange loops has a mechanical filter in fluid communication with the pulsed power scale prevention module.

4. The vapor compression distillation system of claim 1, wherein the evaporation loop includes an evaporation tank and a heat exchanger each having a solids collection and discharge port.

5. The vapor compression distillation system of claim 1, wherein each of the pre-evaporation heat exchange loops includes a heat exchanger having a solids collection and discharge port.

6. The vapor compression distillation system of claim 1, wherein surfaces in contact with fluid are coated with a flouropolymer.

7. The vapor compression distillation system of claim 1, wherein the evaporation loop and the plurality of pre-evaporation heat exchange loops comprise a temperature gradient having discreet temperature zones, each of the evaporation loop and the plurality of pre-evaporation heat exchange loops comprising a discreet temperature zone.

8. A vapor compression distillation system comprising:
an evaporation loop having a recirculation loop; and
a plurality of pre-evaporation heat exchange loops in fluid communication with the evaporation loop, each of the recirculation loop and the plurality of pre-evaporation heat exchange loops having a pulsed power scale prevention module.

9. The vapor compression distillation system of claim 8, wherein each of the recirculation loop and the plurality of pre-evaporation heat exchange loops has a recirculation pump in fluid communication with the pulsed power scale prevention module.

10. The vapor compression distillation system of claim, wherein each of the recirculation loop and the plurality of pre-evaporation heat exchange loops has a mechanical filter in fluid communication with the pulsed power scale prevention module.

11. The vapor compression distillation system of claim 7, wherein the evaporation loop includes an evaporation tank and a heat exchanger each having a solids collection and discharge port.

12. The vapor compression distillation system of claim 7, wherein each of the pre-evaporation heat exchange loops includes a heat exchanger having a solids collection and discharge port.

13. The vapor compression distillation system of claim 7, wherein surfaces in contact with fluid are coated with a flouropolymer.

14. The vapor compression distillation system of claim 7, wherein the evaporation loop and the plurality of pre-evaporation heat exchange loops comprise a temperature gradient having discreet temperature zones, each of the evaporation loop and the plurality of pre-evaporation heat exchange loops comprising a discreet temperature zone.

15. A vapor compression distillation system comprising:
an evaporation loop having a recirculation loop, the recirculation loop including a pulsed power scale prevention module and a recirculation pump; and
a plurality of pre-evaporation heat exchange loops in fluid communication with the evaporation loop, each of the plurality of pre-evaporation heat exchange loops having a pulsed power scale prevention module and a recirculation pump.

16. The vapor compression distillation system of claim 15, wherein each of the recirculation loop and the plurality of pre-evaporation heat exchange loops has a mechanical filter in fluid communication with the pulsed power scale prevention module.

17. The vapor compression distillation system of claim 15, wherein the evaporation loop includes an evaporation tank and a heat exchanger each having a solids collection and discharge port.

18. The vapor compression distillation system of claim 15, wherein each of the pre-evaporation heat exchange loops includes a heat exchanger having a solids collection and discharge port.

19. The vapor compression distillation system of claim 15, wherein surfaces in contact with fluid are coated with a flouropolymer.

20. The vapor compression distillation system of claim 15, wherein the evaporation loop and the plurality of pre-evaporation heat exchange loops comprise a temperature gradient having discreet temperature zones, each of the evaporation loop and the plurality of pre-evaporation heat exchange loops comprising a discreet temperature zone.
